(19) United States
(12) Patent Application Publication
(10) Pub. No.: US 2024/0211229 A1
(43) Pub. Date: Jun. 27, 2024

(54) DEVICES, SYSTEMS, AND METHODS FOR DEVELOPING VEHICLE ARCHITECTURE-AGNOSTIC SOFTWARE

(71) Applicant: ElectroKnox Corporation, Mountain View, CA (US)

(72) Inventors: Ziyang (Brian) XIONG, San Jose, CA (US); Xiangtao YOU, San Jose, CA (US); Xinlei QIU, Palo Alto, CA (US)

(73) Assignee: ElectroKnox Corporation, Mountain View, CA (US)

(21) Appl. No.: 18/556,469

(22) PCT Filed: Apr. 20, 2022
(86) PCT No.: PCT/US2022/071820

§ 371 Date: Oct. 20, 2023

Related U.S. Application Data
(60) Provisional application No. 63/177,193, filed on Apr. 20, 2021.

(51) Int. Cl. G06F 8/61; G06F 8/30; H04L 12/40

(52) U.S. Cl. CPC G06F 8/61; G06F 8/30; H04L 12/40; H04L 2012/40215; H04L 2012/40273

(57) ABSTRACT

A method of programming a programmable unit of a vehicle with a plurality of electronic control units (“ECUs”) is disclosed herein. The method can include developing software to be deployed on the programmable unit of the vehicle with a computer-based platform including a hardware abstraction layer, a transport layer, and a service layer. Developing the software can include: interfacing with the ECUs, concealing a vehicle-specific configuration of the ECUs, eliminating ECU-specific dependencies for the software, integrating a first vehicle communication protocol associated with the software with a second vehicle communication protocol associated with the ECUs, and developing the software via a plurality of application programming interfaces. After developing the software, the method can include deploying the software to the vehicle for installation on the programmable unit.

### CROSS-REFERENCE

This application claims the benefit under 35 U.S.C. § 119(e) of U.S. Provisional Application Ser. No. 63/177,193 filed Apr. 20, 2021, entitled “DEVICES, SYSTEMS, AND METHODS FOR DEVELOPING VEHICLE ARCHITECTURE-AGNOSTIC SOFTWARE,” the contents of which is hereby incorporated by reference in its entirety herein.

### BACKGROUND

Modern vehicles include complex architectures of computers, sensors, and controls, including electronic control units (ECUs) that are configured to optimize or control various systems/components of the vehicle. The systemization of the modern vehicle is only increasing, as most vehicle manufacturers continue to invest in electrification, autonomy, and shared connectivity. For example, the modern automobile usually includes over one-hundred different ECUs. Accordingly, the software and platforms that integrate—and in many cases, implement—the many technological components of a vehicle's architecture can greatly affect the overall performance and functionality of the vehicle itself. However, conventional software for vehicles is hardware-specific, meaning they are uniquely developed for a particular vehicle's architecture.

For example, traditional vehicle architectures are typically distributed and decentralized, meaning each ECU is limited in its interfaces and degree of integration. Vehicle manufacturers have recently been trending towards centralized, domain, and zonal-based architectures-all of which aggregate the interconnectivity and functionality of a vehicle's ECUs and components, to varying degrees. Additionally, a vehicle's architecture can vary based on type, model, make, or brand of the vehicle. Since vehicle architectures can vary, and conventional software and platforms are hardware-specific, Original Equipment Manufacturers (OEMs) are limited in their ability to develop proprietary applications that can be universally adopted across their product line. Consequentially, OEMs typically outsource the development of such applications, thereby surrendering control to software vendors that lack intimate understanding of the OEM's vehicle architecture. Outsourcing software development is not only inefficient, but it can also adversely affect integration of a vehicle's hardware, communication between ECUs, protocol compatibility, and ultimately, a user's overall experience with the vehicle.

### SUMMARY

In one general aspect, the present disclosure is directed to a method of programming a programmable unit of a vehicle with a plurality of electronic control units (“ECUs”) is disclosed herein. The method can include developing software to be deployed on the programmable unit of the vehicle with a computer-based platform including a hardware abstraction layer, a transport layer, and a service layer. Developing the software can include: interfacing with the ECUs, concealing a vehicle-specific configuration of the ECUs, eliminating ECU-specific dependencies for the software, integrating a first vehicle communication protocol associated with the software with a second vehicle communication protocol associated with the ECUs, and developing the software via a plurality of application programming interfaces. After developing the software, the method can include deploying the software to the vehicle for installation on the programmable unit.

In another general aspect, the present disclosure is directed to a system configured to develop architecture agnostic software for a vehicle including a plurality of ECUs. The system can include: a server configured to host a platform configured to interface with the plurality of ECUs, the platform including: a hardware abstraction layer configured to interface with the plurality of ECUs wherein the hardware abstraction layer includes a plurality of vehicle-bus drivers, and wherein the hardware abstraction layer is configured to conceal a specific hardware configuration of the the plurality of ECUs and eliminate hardware-specific dependencies for the plurality of ECUs; a transport layer configured to integrate a first vehicle communication protocol, with a second vehicle communication protocol, wherein the first vehicle communication protocol and second vehicle communication protocol are configured to facilitate communications between the architecture agnostic software and the plurality of ECUs; and a service layer, wherein including a plurality of application programming interfaces (“APIs”) standardized to provide a plurality of application services configured to enables the iteration of the architecture agnostic software.

### FIGURES

Various embodiments are described herein by way of example in connection with the following figures, wherein:

FIG. 1 illustrates a system diagram of a distributed vehicle architecture that requires architecture-specific software;

FIG. 2 illustrates a system diagram of a platform (FIG. 2) according to at least one non-limiting aspect of the present disclosure;

FIG. 3 illustrates a system diagram of a vehicle communications software engine for use with the vehicle architecture of FIG. 1 and platform of FIG. 2 according to at least one non-limiting aspect of the present disclosure; and

FIG. 4 illustrates a system configured to host the platform of FIG. 2 and the vehicle communications software engine of FIG. 3.

### DESCRIPTION

The present disclosure is directed to, in various aspects, devices, systems, and methods for developing and implementing architecture-agnostic software and platforms for a vehicle. According to certain non-limiting aspects of the present disclosure, the vehicle can be an automobile. However, it shall be appreciated that such non-limiting aspects are exclusively presented for illustrative purposes. As such, the term “vehicle” shall be understood to encompass any number of means of transportation, including motorcycles, boats, trains, railcars, and/or airplanes, amongst others. Such vehicles can be used in a variety of applications, including commercial, agriculture, aerospace, or construction industries, with varying degrees of autonomy. Likewise, the term “vehicle architecture” shall be understood to encompass a physical or virtual layout of a vehicle system-including its subsystems and components—as well as the internal communications network that interconnects components throughout the vehicle system.

For example, according to some non-limiting aspects, the vehicle can be an automobile. According to other non-limiting aspects, the vehicle can be an electric air-taxi or delivery drone, which would require inter-component communication, large volume real-time data processing, and shared cloud-connectivity. By addressing these core vehicle needs, the devices, systems, and methods disclosed herein can be seamlessly integrated into the development of such units with high quality, low cost, and fast time-to-market.

It shall be further appreciated that the devices, systems, and methods disclosed herein can be implemented via any computer and/or system specifically configured to perform the functions disclosed herein. For example, the devices, systems, methods, platforms, and software contemplated by the present disclosure can include any processor or logic-based controller, or multiple processors or controllers as the case may be. Alternatively, a processor can include a customized, application-specific integrated circuit (ASIC's) or field-programmable gate array (FPGA). Additionally, it shall be appreciated that the platforms and software engines disclosed herein can be stored in or on a memory of a computer-based development system that is implemented across a computational architecture and configured to interface with a particular physical and/or virtual vehicle architecture. The vehicle architecture can be decentralized, distributed, centralized, domain-based, or zonal. According to some non-limiting aspects, the computational architecture can be remotely located relative to a user, who can access the platforms and software engines disclosed herein via the cloud.

Additionally, the systems, platforms, and software engines disclosed herein can utilize hardware abstraction to isolate hardware changes and complexity via a middleware product that can be used on an embedded system to facilitate rapid and effortless application development, which will promote the adoption of innovation in vehicles, including autonomy. As such, it shall be appreciated that the systems, platforms, and software engines disclosed herein can be easily adapted for non-vehicle use, including implementations in machinery, robotics, and industrial equipment.

As previously discussed, according to conventional vehicle development models OEMs typically outsource software development to several companies (e.g., Tier 1 Suppliers, Tier 2 Suppliers, etc.). Tier 1 Suppliers generally design highly-specialized software modules that are custom-built for proprietary hardware, which is in turn implemented throughout the vehicle architecture. This generally results in OEMs owning less than 10% of a vehicle's software, which can complicate system updates, recalls, and product liability issues. The lack of ownership can increase the amount of non-recurring engineering required when OEMs refresh a product line by revising an existing model or developing a new model. These development efforts are exacerbated by the specification, change request, and integration testing for software updates, which can implicate many suppliers and/or layers of suppliers. Requirement flow-downs alone can delay a new vehicle's time-to-market. Additionally, each Tier 1 Supplier generally has a limited view of the overall vehicle software architecture, and the combined input from multiple Tier 1 Suppliers can compromise the cohesiveness of the integrated vehicle architecture, as suppliers tend to lack a big-picture appreciation of the vehicle architecture and the vehicle as a whole.

In response to these challenges, OEMs have sought to transition vehicle architectures from distributed networks to aggregated domains, zones, and/or completely centralized networks. These efforts have mainly focused on the development of high-performance vehicle computers for the improved routing and processing of messages and signals, regardless of protocol to improve the functionality of ECUs, sensors, and actuators, and the vehicle architecture as a whole. However, improved software and platforms can provide similar technological improvements and, although consortiums such as AUTomotive Open System ARchitecture (AUTOSAR) have attempted to standardize vehicle software and development, such efforts have failed due to a high cost of membership, inaccessibility of the requisite development tools, generation of complex code that is difficult to understand and/or manipulate, and a lack of common understanding and interpretation of the actual standards. Additionally, tools used by vendors that are members of AUTOSAR often lack mutual compatibility due to each vendor's interpretation of the same standards. Since it was first founded nearly twenty years ago, AUTOSAR unfortunately, has not made significant advancements in simplifying vehicle software development. While these efforts have failed, OEMs continue to invest in electrification, autonomy, and shared connectivity, which worsen the aforementioned problems.

At the highest level, the present disclosure is directed to a vehicle middleware platform and communications software-based engine, which provide hardware abstraction, message routing, data transport, and expandable services for vehicle software development. Aspects of the present disclosure can satisfy the need for enhanced devices, systems, and methods for developing software that is hardware agnostic and thus, capable of technologically improving the performance of any vehicle architecture. For example, the architecture-agnostic systems, methods, and software disclosed herein can provide several technological improvements. First, architecture-agnostic software can actually improve the integration between software and hardware. Second, architecture-agnostic software can improve multi-protocol vehicle communications and thus, improve communication throughout the vehicle architecture. Third, architecture-agnostic software can consolidate and streamline heritage vehicle bus network protocols and newer Ethernet-based protocols. Fourth, architecture-agnostic software can improve the versatility of the vehicle architecture and facilitate continual development and evolution. These are just some of the technological improvements offered by the present disclosure, which practically integrate the functions performed by the software disclosed herein and transform the way in which software can be developed for any vehicle architecture, old and new alike. Thus, the present disclosure can be implemented to produce vehicles that are more efficient, capable, and effective than those running conventional, hardware-specific software.

Architecture-agnostic software can actually improve the integration between software and hardware. ECU hardware and software on the market today are custom developed for each specific vehicle model for each automaker or brand. Custom developing such ECU hardware and software is a labor intensive and time-consuming process, with automotive OEMs and suppliers handing off documents describing specifications then waiting for long periods of time between iterations of product modifications. ECU software development is often further outsourced to Tier 2 Suppliers with yet another level of removal from carmakers. Furthermore, component- and system-level testing often cannot uncover all potential issues in design and implementation of either individual electronic components or vehicle as a whole. Vehicle-level integration is sometimes where the most severe, thus difficult to correct, design issues surface. Cost of development, integration, as well as verification and validation run high as multiple rounds of testing and adjustments through change requests must be completed before both software and hardware can be updated for another round of integration testing. When automotive OEMs create a different model of vehicles or make changes to existing models, the process of specification, change request, and integration testing, which involves not only multiple Suppliers for different components, but also multiple layers of Suppliers, must be repeated again several times, resulting in high development cost and delayed time-to-market. Architecture-agnostic software decouples development cycle of vehicle hardware and software with clearly defined interfaces (“APIs”), thus improving hardware-software integration.

Additionally, architecture-agnostic software can improve multi-protocol vehicle communication thus improve communication throughout the vehicle architecture. Introduction of autonomous driving brought more sophisticated sensors and devices in large numbers into vehicle design. These new components create new services and features inside vehicles and generate additional data in large quantities, eg., images and videos. Traditional vehicle communication protocols (eg., CAN, LIN, and FlexRay are some of the more common examples of such protocols) are low bandwidth and transmit data at low speeds, therefore are unable to meet the needs of new Advanced Driver-Assistance Systems (ADAS) and autonomous driving components. Advanced vehicle autonomy features demand uses of Ethernet protocol that is higher in speed and in bandwidth. Ethernet has been commonly used in consumer electronics for transmitting large amounts of data while most part of vehicle design lags behind in adopting Ethernet. Large data set transmission over Ethernet using standard automotive protocols such as SOME/IP has limitations such as lack of standard APIs, requiring binding service objects, transport layer technology dependent, and lack of native security solution and Quality of Service policy. A modular, expandable, and hardware—and cloud-agnostic vehicle software development platform is needed to offer shared base functions so that it can be deployed to vehicles regardless of model, make, and brand. Such a universal software development platform will function as the basis for the overall software architecture of the entire vehicle, as well as providing a level of hardware abstraction such that changing hardware does not shake up the entire vehicle software stack. Furthermore, this new middleware solution, when offered with standard APIs, can further isolate higher level, user-facing vehicle application development from underlying hardware or vehicle architecture.

Furthermore, architecture-agnostic software can consolidate and streamline heritage vehicle bus network protocols and newer Ethernet-based protocols. In classic vehicle E/E architecture, individual ECUs are responsible for communicating with each other via a number of data pipelines (or buses) using traditional data transfer protocols (CAN, LIN. FlexRay, etc) that emerged over time. Each of these protocols express data using unique and specialized formats. Today's vehicles use a mixture of these myriad communication protocols, now with the addition of Ethernet, a protocol that does not use vehicle bus network. The legacy and the new will continue to coexist and mingle in vehicles for the foreseeable future due to design considerations and concerns over cost. Each uses its own file format (DBC, ARXML, LDF, FIBEX, etc) to organize and communicate data and configurations information. Translations between protocols is necessary to ensure interoperability. Creating software to manage inter-protocol routing proves to be difficult and poses great challenges to automotive software development. With the number of ECUs and vehicle feature/application complexity both on the rise, OEMs are in need of a better approach to manage vehicle communication complexity and difficulty in vehicle design and integration of large number of ECUs.

Architecture-agnostic software can also improve the versatility of the vehicle architecture and facilitate continual development and evolution. Vehicle and component software development are highly specialized and proprietary to the hardware depending on OEM specification and suppliers who are involved. Once developed, the software cannot be easily ported to a different hardware component or vehicle. Conversely, changing hardware in a vehicle requires not only updating software which resides on the changed hardware, but also software in other hardware components linked or communicate with the changed component. Software for vehicle computers became even more complex as well, going beyond communications routing data amongst functional domains of the vehicle to also fulfilling functionality previously served by hardware components and providing advanced computations for machine learning and neural networks. While its functionality may be similar to consumer electronics in theory, due to the large number of components involved, complexity of vehicles to function as both transportation and connectivity vessel, coupled with the demand for vehicle functional safety for the safety of drivers, passengers, and vehicle alike, vehicle computer control software is more difficult to design and implement than consumer electronics by orders of magnitude.

As will be discussed, the architecture-agnostic systems and software disclosed herein can be modular, expandable, and hardware-agnostic, and/or cloud-based. They enable shared base functions so that it can be deployed to vehicles regardless of model, make, and brand. This universality produces a basis for the overall architecture of an entire vehicle. However, the modularity disclosed herein provides a level of hardware abstraction such that changing hardware does not shake up the entire vehicle software stack. Furthermore, this new middleware solution, when encapsulated by standard application programming interfaces (“APIs”) can further isolate higher-level, user-facing vehicle application development from underlying hardware or vehicle architecture.

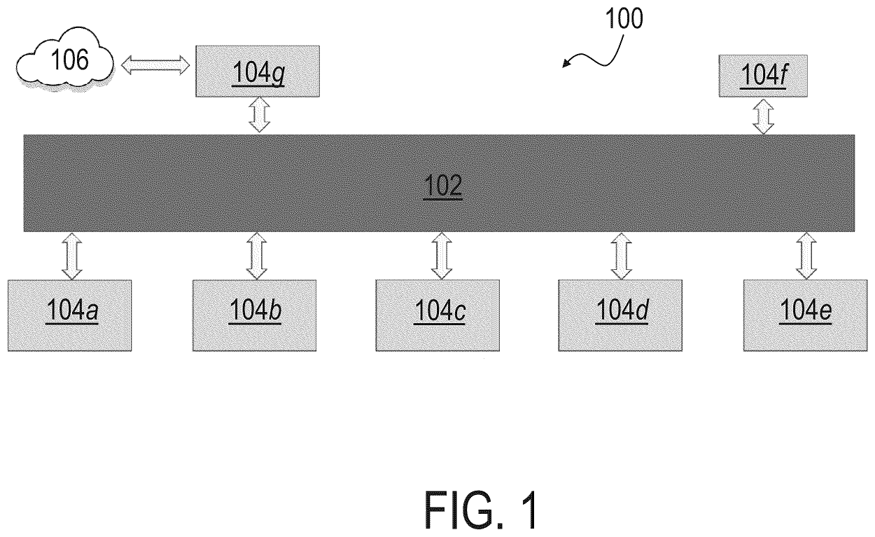

Referring now to FIG. 1, a system diagram of a distributed vehicle architecture 100 featuring a gateway 102 configured to interface with numerous subsystems and components is depicted in accordance with at least one non-limiting aspect of the present disclosure. According to the non-limiting aspect of FIG. 1, the vehicle architecture 100 can include an advanced driver assistance system (ADAS) 104a, a body and comfort control unit 104b, a powertrain and thermal control unit 104c, a thermal control unit 104d, a user interface control unit 104e, an onboard diagnostics control unit 104f, and a communications control unit 104g. The communication control unit 104g may be configured to be communicably coupled to a server 106 via any number of wired or wireless communications, including both long-range and/or short-range networks. For example, the communication control unit 104g can be configured for WiFi®, 4G or 5G cellular. Bluetooth®, and/or nearfield (NFC) communications, amongst others. Similarly, it shall be appreciated that the term “communicably coupled”, as used herein, can refer to any type of wired and/or wireless connection between components, subsystems, and/or servers.

If an OEM were to develop software for the conventional gateway 102 and/or each of the ECUs 104a, 104b, 104c, 104d, 104e, 104f, 104g of the conventional vehicle architecture 100 of FIG. 1, it would likely implicate multiple Tier 1 Suppliers, and could potentially require the involvement of many Tier 2 Suppliers and below. This poses a significant systems engineering challenge and, as discussed above, the requirements flow-downs alone would drive up costs, promote inefficiency and a lack of synergy, and would expose the vehicle architecture 100 to human error. Additionally, the vehicle architecture 100 of FIG. 1 illustrates the ineffectiveness of hardware-specific software and platforms and highlights the need for architecture-agnostic software and platforms disclosed herein.

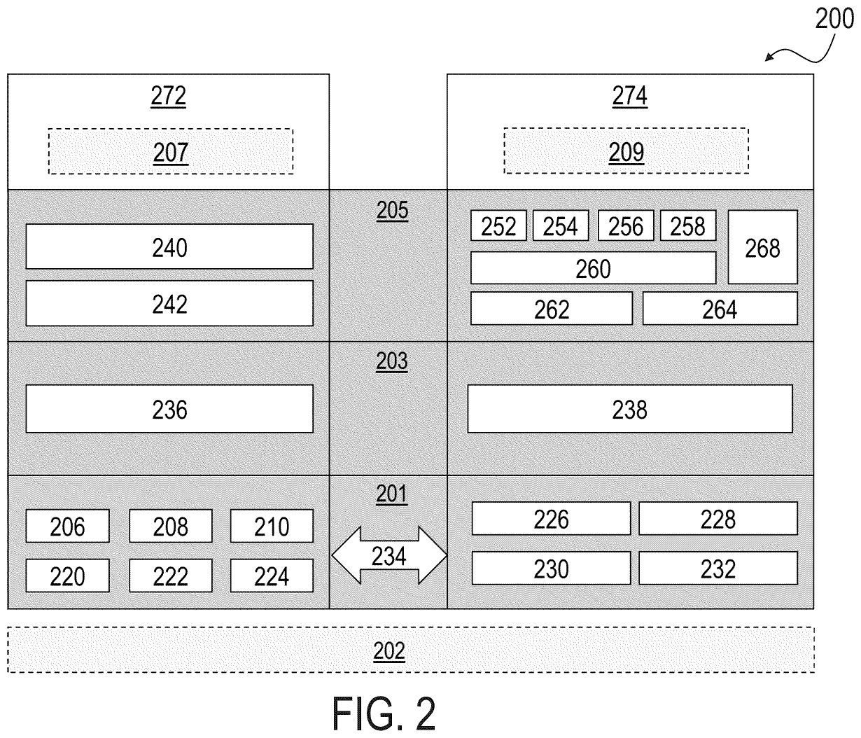

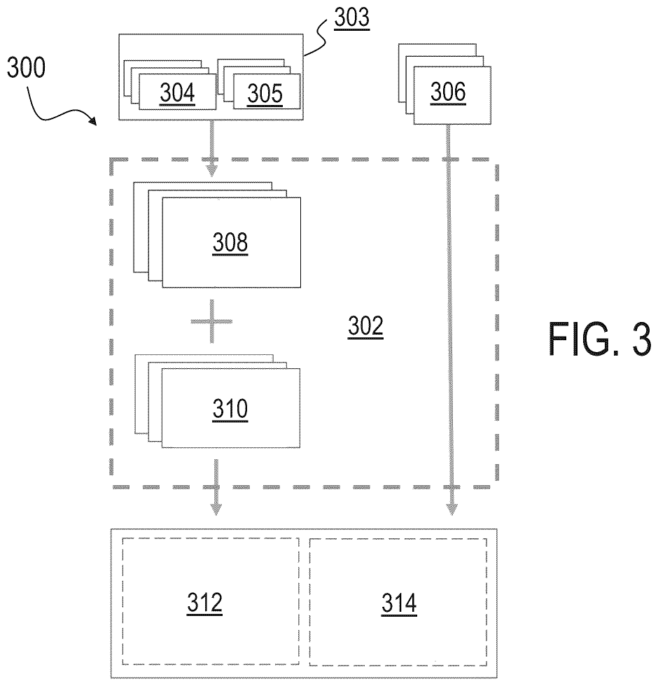

Although the non-limiting aspect of FIG. 1 illustrates a distributed vehicle architecture 100, it shall be appreciated that the platform 200 (FIG. 1) and software engine 300 (FIG. 3) disclosed herein can be similarly implemented to develop software for vehicle architectures of any configuration. For example, according to other non-limiting aspects, the platform 200 (FIG. 2) and software engine 300 (FIG. 3) can be implemented to develop software for decentralized, centralized, domain-based, or zonal vehicle architectures, amongst others.

Referring now to FIG. 2, a system diagram of a platform (FIG. 2) 200 is depicted in accordance with at least one non-limiting aspect of the present disclosure. The platform 200 of FIG. 2 can simplify vehicle software development to enable and empower OEMs and suppliers to efficiently and autonomously develop vehicle features and applications that are technologically improved. The platform 200 can be configured to interface with hardware 202 of a vehicle architecture 100 (FIG. 1), which can be either physical or virtually simulated. In the non-limiting aspect where the vehicle architecture 100 (FIG. 1) is simulated, it can also be cloud-based, which further facilitates flexibility of software development. Generally, the platform (FIG. 2) 200 can be implemented as a vehicle middleware platform capable of hardware 202 abstraction, message routing, data transport, and expandable services for a vehicle's architecture 100 (FIG. 1). According to the non-limiting aspect of FIG. 2, the platform 200 can include a hardware abstraction layer 201, a transport layer 203, and a service layer 205, hosted by a server configured to interface with a real-time processing unit (RPU) and an application processing unit (APU).

The RPU 272 and APU 274 can each be configured to run an operating system. For example, the RPU 272 can run real-time operating system (RTOS) and the APU 274 can run Linux; however, any operating system can be implemented depending on user preference. The RPU 272 can be configured to perform the processing and computing tasks required by functional safety. Accordingly, the RPU 272 and the APU 274 can be configured to run user-facing applications 207, 209, through which a user can access the platform 200 for software development. Although the APU 274 can be configured to perform non-functional safety processing and computing tasks, it can also be configured to launch and run applications but-similar to a graphics processing unit (GPU). Both the RPU 272 and the APU 274 can facilitate interaction with the vehicle architecture 100 (FIG. 1). According to the non-limiting aspect of FIG. 2, the RPU 272 and the APU 274 can be communicably coupled via a secure inter-processor communications (IPC) link 234, which ensures seamless communication between layers 201, 203, 205 and modules across the platform 200.

Still referring to FIG. 2, the platform 200 can be utilized by OEMs, without the assistance of Tier 1 Suppliers, to develop hardware-agnostic software. The hardware abstraction layer 201 can interface with the hardware 202 of a vehicle, regardless of the particular vehicle's architecture 100 (FIG. 1). According to the non-limiting aspect of FIG. 2, the hardware abstraction layer 201 can include a plurality of vehicle-bus drivers and frameworks, including a functional safety framework 208, an Ethernet driver 220, a control area network (CAN) driver 222, a local interconnect network (LIN) driver 224, and/or other device drivers 206. The plurality of vehicle-bus drivers and frameworks in RPU 272 can communicate with a second plurality of drivers and frameworks in APU 274, including a second IPC framework 226, a second functional safety framework 228, a second Ethernet driver 230, and/or other device drivers 232. The aforementioned drivers and frameworks can communicate via a secure inter-processor communication (IPC) link 234.

It shall be appreciated that the aforementioned drivers and frameworks of the hardware abstraction layer 201 can collectively generalize interaction with the hardware 202 of a vehicle architecture 100 (FIG. 1). In other words, the hardware abstraction layer 201 can include the minimum drivers and frameworks necessary to interact with hardware 202, such as an ECU of a vehicle, at a general or abstract level rather than at a detailed hardware level. In either case, the calling program can interact with the device in a more general way than it would otherwise. The particular configuration of frameworks and drivers hosted by the hardware abstraction layer 201 can exploit similarities in vehicle architectures 100 (FIG. 1), enabling the mapping of virtual resources (e.g. software) to physical resources (e.g., hardware 202) via native hardware for computations by the RPU 272 or APU 274. For example, when the platform 200 communicates with the hardware 202, the hardware abstraction layer 201 can multiplex, meaning it transmits multiple signals and/or messages simultaneously on multiple circuit or channel to the hardware 202.

In further reference to FIG. 2, the hardware abstraction layer 201—and specifically, the various frameworks and drivers—can be configured to trap every privileged instruction execution and pass it to the appropriate layer of the platform 200 for resolution. The secure IPC link 234 assists in isolating and routing messages and signals to the appropriate component of the platform 200, regardless of its source and destination (e.g., platform layer 201, 203, 205 and/or hardware 202). According to the non-limiting aspect of FIG. 2, the hardware abstraction layer 201 can be configured to run on different physical and/or virtual configurations, including parallel virtualizations or host-based virtualizations, depending on user-preference.

Still referring to FIG. 2, the platform 200 can facilitate the use of new technologies and/or protocols to make new vehicle features possible. For example, the transport layer 203 can integrate heritage vehicle communications, such as CAN/LIN/FlexRay via traditional communication buses with those commonly employed by more innovative, autonomous driving technologies (e.g., Data Distribution Services, Ethernet). This combined functionality is particularly critical for modern vehicles. For example, autonomous vehicles rely on sensors, cameras, radar, and lidar, all of which demand high bandwidth and low latency data transfer across multiple vehicle domains. However, these features are not achievable by more conventional, low bandwidth protocols. Alternatively, data transfer protocols evolved from traditional automotive vehicle communications for specific service implementations (e.g., SOME/IP) are still widely implemented, and the platform 200 must enable each communication node to keep track of its more conventional peers when communicating messages and/or signals to the hardware 202. In comparison, DDS is much more dynamic and flexible, putting much less stringent demands on higher level applications. In addition, the transport layer 203 takes full advantage of modern and heritage protocols by: supporting both publish/subscribe and request/response models to provide additional communication flexibility and utilizing Remote Procedure Call (RPC) over DDS to further improve communication flexibility and performance.

According to the non-limiting aspect of FIG. 2, the transport layer 203 can include one or more transport interfaces 236, 238. The transport layer 203 of the platform 203 can provide efficient, high bandwidth data transport among vehicle domains of the architecture 100 (FIG. 1). As previously described, the transport interfaces 236, 238 of the transport layer 203 can be configured to support a wide variety protocols, including conventional automotive protocols such as CAN, LIN, and FlexRay and the more modern high speed protocols, such as Ethernet. For example, one of the transport interfaces 236, 238 can be configured for DDS, which can facilitate real-time machine-to-machine (sometimes called middleware or connectivity framework) communications capable of dependable, high-performance, interoperable, real-time, scalable data exchanges via a publish-subscribe pattern. According to the non-limiting aspect wherein the transport layer utilizes DDS, the platform 200 can facilitate large volumes of data generated by the hardware 202 (e.g., sensors, cameras), as implemented across the vehicle architecture 100 (FIG. 1), which is processed by the vehicle using an automotive computational and communications software engine prior to being securely transmitted to vehicle domains via the secure IPC 234.

Additionally and/or alternatively, the transport layer 203 can be configured to utilize Time Sensitive Network (TSN) protocols for deterministic communications over standard Ethernet for increased bandwidth, improved levels of connectivity, and optimized transport of data and signals. Accordingly, the transport interfaces 236, 238 can enable improved communication between developed software and the hardware 202, vehicle architecture, which improves communication throughout the entire vehicle architecture 100 (FIG. 1). The transport layer 203 of FIG. 3 resolves many transport issues that have limited the progress of AUTOSAR, including the data transmission protocol incompatibility. The Platform 200 (FIG. 2) enables easy communication combinations of protocols, giving OEMs freedom to reconfigure or modernize a vehicle architecture 100 (FIG. 1) using proven technology while also taking advantage of emerging innovations.

In further reference to FIG. 2, the service layer 205 of the platform 200 can provide additional services and utilities to provide a standardized platform for developing higher level software and applications. According to the non-limiting aspect of FIG. 2, the service layer 205 can include application utilities (e.g. logging, data analytics, etc.) 240, 260 and/or communication service application programming interfaces (“APIs”) 242, 262, timing service 252, security service 254, cloud service 256, diagnostic stacks 258, data distribution services 264, and/or edge computing 268. Any component of the service layer 205 can be standardized to provide application services such as logging, diagnostics, data analytics, security, cloud, as well as APIs for communications and edge computing, which can be used for the development of custom software or applications. Thus, the service layer 205 enables OEM flexibility to iterate and update software via user facing applications 207 and 209 with speed and agility to provide new features for better user experience, fix newly discovered issues, or enhance existing features separately from underlying hardware.

Having described the construct of the platform 200 and each of the hardware abstraction layer 201, transport layer 203, and service layer 205, the implementation of the platform 200 to develop architecture-agnostic software will now be described. Generally, the hardware abstraction layer 201 can be configured to conceal the specific hardware 202 complexity and/or configuration of the underlying vehicle architecture 100 (FIG. 1) and thus, can break the dependencies that historically limited vehicle software development. Thus, the platform 200 of FIG. 2 can separate hardware 202 development from software development, allowing OEMs to experiment and move seamlessly across different hardware 202 platforms. This flexibility can be further enhanced when the hardware 200 constitutes a cloud-based, virtualized infrastructure. Via the platform 200 of FIG. 2, software does not need to be developed from scratch for new models or updated existing models, which shortens the development cycle, lowers cost, and accelerates products to market.

The platform 200 can enable software engineers from a wider range of backgrounds to develop vehicle software features and applications that are vehicle-specific software, without specialized knowledge of a vehicle architecture 100 (FIG. 1) and/or its components. This can alleviate a longstanding shortage of software talent with specialized automotive or automotive hardware expertise. Bridging traditional vehicle system engineering and software development, the Platform (FIG. 2) allows automakers to continue to leverage existing system engineers on staff to specify vehicle EE architecture while expanding software organization almost independently. Building hardware-independent, brand-distinguishing features and applications and achieving “software-defined vehicle” are achievable and realistic with the Platform (FIG. 2). Additionally, it is much more attainable for OEMs to acquire a full big picture design of whole vehicle software architecture. Features such as vehicle-wide OTA and centralized vehicle security become achievable to save cost and offer a better user experience.

Referring now to FIG. 3, a system diagram of a vehicle communications software engine 300 for use with the vehicle architecture 100 of FIG. 1 and the platform 200 of FIG. 2 is depicted in accordance with at least one non-limiting aspect of the present disclosure. The software engine 300 can be configured to convert messages transmitted throughout and between the platform 200 (FIG. 2) and vehicle architecture 100 (FIG. 1) into a universal format, thereby promoting the development of architecture-agnostic software. According to the non-limiting aspect of FIG. 3, the software engine 300 can include a converter 302 configured to interface with vehicle network description files hosted by one or more servers 303. The files can include, for example, an AUTOSAR (ARXML) file 304 and/or a database container (DBC) file 305. The converter 302 can be implemented as a software tool that serves as the universal vehicle communications translator and program generator. According to other non-limiting aspects, the converter 302 can include a collection of software programs that cover end-to-end, vehicle-to-cloud software features, services, and APIs. As such, the converter 302 can be configured to be file format agnostic, meaning it can receive any file format and convert it into the standard format described below.

According to the non-limiting aspect of FIG. 3, the converter 302 can be configured to receive files 304, 305 and convert them into a universal message format for transmission to an architecture-agnostic software development platform 200 (FIG. 2). Additionally and/or alternatively, the converter 302 can be configured to interface with other files. For example, according to the non-limiting aspect of FIG. 3, the converter 302 can receive and convert object-based interface definition language (IDL) files 306 for transmission to the platform 200 (FIG. 2). Other files contemplated as inputs to the converter 302 by the present disclosure include extensible markup language (XML) and JavaScript open notation (JSON) files, or any similar hierarchical file formats. It shall be appreciated that any file can be used by the converter 302 of FIG. 3 and the disclosed files are merely intended for illustrative purposes. For example, LDF files for LIN, and FIBEX for FlexRay are files contemplated by other non-limiting aspects of the present disclosure. Accordingly, the converter 302 of FIG. 3 enables OEMs to use any file format of their choosing to customize and extend software to run ubiquitously in any vehicle architecture.

Regardless of the format of the file inputs 304, 305, 306, the converter 302 reformats messages and signals received from the vehicle architecture 100 (FIG. 1) into a universal vehicle communication description format. This universal format can be used to describe all messages and/or signals carried on different automotive buses regardless of the underlying protocol. Other objects and entities can be described using this Description Format as well to provide configurations of additional vehicle applications and features. Such objects are organized in groups called Nodes. Here is an example:

```
<NODE>
  <SHORT-NAME>SGW</SHORT-NAME>
  <BUSES>
    <BUS>
      <SHORT-NAME>ADAS1</SHORT-NAME>
      <FRAMES>
        <FRAME>
          <SHORT-NAME>KINEMATICS</SHORT-NAME>
          <DIRECTION>TX</DIRECTION>
          <PROTOCOL>CAN</PROTOCOL>
          <LENGTH>8</LENGTH>
          <CYCLE>0</CYCLE>
          <PDUS>
            <PDU>
              <SHORT-NAME>KINEMATICS</SHORT-NAME>
              <ID>0x24</ID>
              <START>0</START>
              <LENGTH>8</LENGTH>
              <SIGNALS>
                <SIGNAL>
                  <SHORT-NAME>ACCEL_Y</SHORT-NAME>
                  <START-BIT>−40</START-BIT>
                  <BIT-SIZE>10</BIT-SIZE>
                  <OFFSET>−18.375</OFFSET>
                  <FACTOR>0.03589</FACTOR>
                  <UNIT>m/s\hat{ }2</UNIT>
                  <MIN>0</MIN>
                  <MAX>65535</MAX>
                </SIGNAL>
```

The converter 302 can be further configured to transmit the converted messages and signals software libraries and/or other low-level APIs 312 and/or auto-generated vehicle-specific software APIs 314 in C/C+ for customized software development. These can either be components of the platform 200 (FIG. 2) or can be separate systems configured to transmit inputs from the converter 302 to the platform 200. As such, the software engine 300 and converter 302 of FIG. 3 can ensure that the platform 200 (FIG. 2) can ubiquitously communicate with 202 (FIG. 2) components of the vehicle architecture 200 (FIG. 2), regardless their native format or language. This shields software application developers from vehicle hardware complexities by enabling the use of standard APIs in C/C++ on the platform 200 (FIG. 2). As such, the converter 302 liberates programmers from specialized automotive system knowledge and enables OEMs to better tackle and control the development of software and thus, the evolution of their vehicles. OEMs thus have a much larger talent pool of embedded software engineers to hire from. Making the paradigm shift to software defined vehicle architecture is therefore not only possible, but also easier and faster to achieve when using the Platform (FIG. 2).

Additionally, the software engine 300 of FIG. 3—and more specifically, the converter 302—can be configured to further customize non-universal inputs by modifying routing rules without writing any custom software. Examples of such customization can include programming additional routing rules, excluding existing routing rules, attenuating existing routing rules, and/or adding or removing entire communication buses that were not present in the input network description files 304, 305, 306. The converter 302 can even add or remove entire ECUs from the message format and/or routing, depending on user preference and/or intended application. The software engine 300 of FIG. 3, in conjunction with the platform 200 of FIG. 2, can provide the standardization, hardware abstraction, and API development and publication that limited previous efforts to make software development for vehicles architecture-agnostic and generally, more efficient. As previously noted, the standardization of message formats separates software development efforts from the underlying hardware by providing shared base functions and publishing standards.

In other words, the software engine 300 can take any file format, of which 304, 305, 306 are merely examples, available on the market today as input and translate the content for architecture-agnostic software development via the platform 200 (FIG. 2). The output files 312, 314 can employ a universal vehicle communication description format and are vendor and standard agnostic. Applications of such customization may be utilized by Automotive OEMs to test variants of vehicle network architecture or experiment with different messages or signals. Design changes in vehicle architecture can be tested with minimal effort to improve productivity of interactions with component suppliers. The resulting lowered development cost and faster time to market help OEMs achieve faster innovation and better profit margin. The platform 200 (FIG. 2) can subsequently create APIs in standard C/C++ programming languages and offer shared lower-level services (in the Service Layer) that are needed by higher level applications to develop brand distinguishing application or easily integrate into cloud infrastructures to offer additional features (such as Over-the-air updates and remote diagnostics) or collect and analyze vehicle data for improved business intelligence.

By providing a standardized vehicle application development platform, application development teams in or outside of an Automotive OEM's organization can develop value-added features and applications that can be run seamlessly on any vehicle that is using the Platform (FIG. 2). Realizing cross domain and cross protocol vehicle network routing, allowing easy creating and testing of new or modified vehicle changes, as well as simplifying vehicle applications and ECU functionality development, the Platform (FIG. 2) greatly simplifies vehicle customization and feature development for lower cost and faster time to market. The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. Further, it is to be understood that the figures and descriptions of the present invention have been simplified to illustrate elements that are relevant for a clear understanding of the present invention, while eliminating, for purposes of clarity, other elements. While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

The software engine 300 of FIG. 3 and platform 200 of FIG. 2 not only simplify vehicle software application and feature development, but also streamline testing of vehicle network features and customizing changes. Vehicle network changes can be tested simply from modifying files expressed in the universal communication format even before any software development takes place. Software development for multiple vehicle models is made easy by the shared base functions, APIs, and hardware and cloud interfaces offered by platform (FIG. 2). Bridging vehicle system engineering and software development. The platform (FIG. 2) bridges traditional vehicle system engineering and vehicle software development. For example, traditional vehicle system engineers are empowered to continue creating vehicle specifications using network description files with tools and languages they're familiar with—OEMs can utilize their existing talent pool of vehicle engineers just as they have been.

The converter 302 translates network description files created by vehicle system engineers into APIs, which bridges the domain knowledge gap between traditional vehicle engineering and software development. Software developers who may not have in-depth knowledge of automotive systems are then enabled to create vehicle features and applications without being limited by expensive specialty tools or be bogged down by the complexity of vehicle architecture and hardware. The software engine 300 of FIG. 3 and platform of FIG. 2 can fit into any vehicle architecture, be it central, domain, or zonal. Likewise, the platform 200 (FIG. 2) and software engine 300 (FIG. 3) can also adapt to any OEM cloud infrastructure and, using edge computing, can reduce cloud data transmission volume. The platform (FIG. 2) can further improve the efficiency of vehicle data gathering.

The platform 200 (FIG. 2) and software engine 300 of FIG. 3 also provide several business benefits to the OEMs including: lowered bar of entry; lower difficulty of development; OEMs gain ownership of vehicle software; reduced reliance on ECU suppliers; OEMs can own more aspects of vehicle creation by easily making changes in software; enhanced customization, allowing quick iterations of vehicle design changes to be made and tested; bridging the gap between traditional vehicle system engineering and modern software development to achieve software-defined vehicle; richer software-based vehicle features; realize vehicle-wide OTA; expedite feature and application development; improved vehicle intelligence; improved usability and accessibility of big data obtained from vehicles for monetization; enables real time data analysis; improved user experience; and improved flexibility and reusability of vehicle features

Although the above benefits are described in the context of improving the software development process for OEMs directly, it shall be appreciated that the platform 200 (FIG. 2) and software engine 300 of FIG. 3 can also be used by suppliers (e.g. Tier 1 Suppliers) to assist their own development efforts. The platform 200 (FIG. 2) may also be used with autonomous driving hardware to bridge network communications gap with existing vehicle network to ease autonomous driving adoption. Additional applications of the platform 200 (FIG. 2) include robotics and non-passenger car vehicles such as farming, trucking, heavy commercial vehicles, mass transportation, and aerospace.

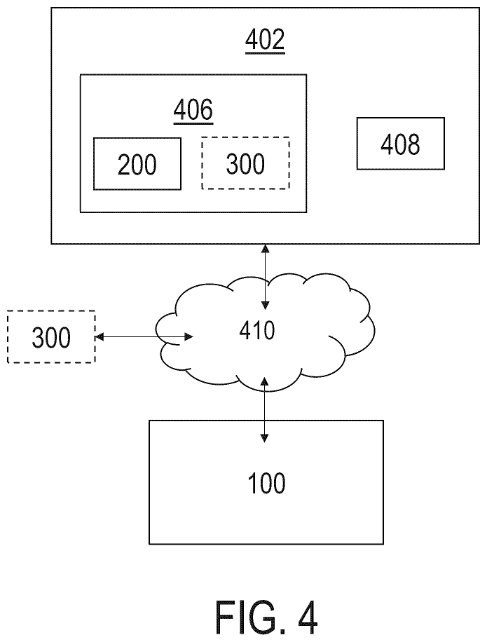

Referring now to FIG. 4, a system 400 configured to host the platform 200 of FIG. 2 and the vehicle communications software engine 300 of FIG. 3 is depicted in accordance with at least one non-limiting aspect of the present disclosure. According to the non-limiting aspect of FIG. 4, the system 400 can include a development subsystem 402 that includes a memory 406 configured to store the platform 200 (FIG. 2) and software engine 300 (FIG. 3). However, according to some non-limiting aspects, the software engine 300 can be stored and implemented remotely relative to the development subsystem 402. The development subsystem 402 of FIG. 4 can further include a processor 408 configured to run the platform 200 (FIG. 2) and software engine 300 (FIG. 3) and perform the functions disclosed herein. The development subsystem 402 can be communicably coupled to a vehicle architecture 100 (FIG. 1) via network 410. As previously discussed, the vehicle architecture 100 (FIG. 1) can be either physically or virtually implemented, depending on user preference and/or intended application. Accordingly, the system 400 of FIG. 4 illustrates merely one hardware configuration capable of running the aforementioned platform 200 (FIG. 2) and software engine 300 (FIG. 3) to realize the benefits disclosed herein.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. Further, it is to be understood that the figures and descriptions of the present invention have been simplified to illustrate elements that are relevant for a clear understanding of the present invention, while eliminating, for purposes of clarity, other elements. While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

Various aspects of the subject matter described herein are set out in the following numbered clauses:

Clause 1: A method of programming a programmable unit of a vehicle, wherein the programmable unit interfaces with a plurality of electronic control units (“ECUs”) of the vehicle, the method including: developing with a computer-based platform hosted on a server remote from the vehicle, software to be deployed on the programmable unit of the vehicle, wherein the computer-based platform includes a hardware abstraction layer, a transport layer, and a service layer, wherein developing the software includes: interfacing, via the hardware abstraction layer, with the ECUs; concealing, via the hardware abstraction layer, a vehicle-specific configuration of the ECUs; eliminating, via the hardware abstraction laver, ECU-specific dependencies for the software; integrating, via the transport layer, a first vehicle communication protocol associated with the software with a second vehicle communication protocol associated with the ECUs; and developing, via the service layer, the software via a plurality of application programming interfaces (“APIs”); and after developing the software, deploying the developed software to the vehicle for installation on the programmable unit.

Clause 2: The method according to clause 1, wherein the server includes a real-time response unit and an application unit configured to host computer-based the platform.

Clause 3: The method according to either of clauses 1 or 2, wherein the hardware abstraction layer includes a plurality of vehicle-bus drivers, wherein the plurality of vehicle-bus drivers includes a first subset of vehicle-bus drivers hosted on the real-time response unit and a second subset of vehicle-bus drivers hosted on the application unit.

Clause 4: The method according to any of clauses 1-3, wherein the vehicle-specific configuration of the ECUs is one of a plurality of ECU configurations the hardware abstraction layer is configured to interface with, and wherein developing the software further includes: detecting, via the plurality of vehicle-bus drivers, a similarity between the vehicle-specific configuration of the ECUs and other ECU configurations of the plurality; and mapping, via the plurality of vehicle-bus drivers, the developed software to an ECU of the plurality based on the similarity.

Clause 5: The method according to any of clauses 1-4, wherein developing the software further includes multiplexing, via the hardware abstraction layer, a plurality of messages simultaneously to the plurality of ECUs of the vehicle via a plurality of interfacing channels.

Clause 6: The method according to any of clauses 1-5, wherein the first subset of vehicle-bus drivers includes at least one of a functional safety framework, an Ethernet driver, a control area network (CAN) driver, and a local interconnect network (LIN) driver, or combinations thereof.

Clause 7: The method according to any of clauses 1-6, wherein the second subset of vehicle-bus drivers includes at least one of a second inter-processor communication (IPC) framework, a second functional safety framework, and a second Ethernet driver, or combinations thereof.

Clause 8: The method according to any of clauses 1-7, wherein the first vehicle communication protocol is a heritage vehicle communication protocol including at least one of a protocol used by a CAN bus, a protocol used by a LIN bus, and a protocol used by a FlexRay bus, or combinations thereof.

Clause 9: The method according to any of clauses 1-8, wherein the second vehicle communication protocol is an newer vehicle communication protocol relative to the first vehicle communication protocol and includes at least one of a Data Distribution Services (DDS) protocol, an Ethernet protocol, and a Time Sensitive Network (TSN) protocol, or combinations thereof.

Clause 10: The method according to any of clauses 1-9, wherein the second vehicle communication protocol is configured for use with a vehicle configured for autonomous driving.

Clause 11: The method according to any of clauses 1-10, wherein a first ECU of the plurality includes a sensor and a second ECU of the plurality includes an automotive computational and communications engine, and wherein the method further includes transferring, via the developed software, data generated by the sensor to the automotive computational and communications engine prior to transferring the data to other ECUs of the plurality.

Clause 12: The method according to any of clauses 1-11, wherein the plurality of APIs includes at least one of a data logging utility, a data analytics utility, a communication service utility, timing service utility, a security service utility, a cloud service utility, a diagnostic stack utility, a data distribution services utility, and an edge computing utility, or combinations thereof.

Clause 13: The method according to any of clauses 1-12, wherein the platform further includes a message conversion software engine, and wherein developing the software further includes: receiving, via the message conversion software engine, files of varying formats from the plurality of ECUs; and converting, via the message conversion software engine, the files into a universal format for development via the APIs of the service layer.

Clause 14: A system configured to develop architecture agnostic software for a vehicle including a plurality of ECUs, the system including: a server configured to host a platform configured to interface with the plurality of ECUs, the platform including: a hardware abstraction layer configured to interface with the plurality of ECUs wherein the hardware abstraction layer includes a plurality of vehicle-bus drivers, and wherein the hardware abstraction layer is configured to conceal a specific hardware configuration of the the plurality of ECUs and eliminate hardware-specific dependencies for the plurality of ECUs; a transport layer configured to integrate a first vehicle communication protocol, with a second vehicle communication protocol, wherein the first vehicle communication protocol and second vehicle communication protocol are configured to facilitate communications between the architecture agnostic software and the plurality of ECUs; and a service layer, wherein including a plurality of application programming interfaces (“APIs”) standardized to provide a plurality of application services configured to enables the iteration of the architecture agnostic software.

Clause 15: The method according to clause 14, wherein the platform is configured to be hosted on a real-time response unit and an application unit.

Clause 16: The method according to either of clauses 14 or 15, wherein the plurality of vehicle-bus drivers include a first subset of vehicle-bus drivers hosted on the real-time response unit and a second subset of vehicle-bus drivers hosted on the application unit, and wherein the first subset of vehicle-bus drivers includes at least one of a functional safety framework, an Ethernet driver, a control area network (“CAN”) driver, and a local interconnect network (“LIN”) driver, or combinations thereof, and wherein the second subset of vehicle-bus drivers includes at least one of a second inter-processor communication (“IPC”) framework, a second functional safety framework, and a second Ethernet driver, or combinations thereof.

Clause 17: The method according to any of clauses 14-16, wherein the first vehicle communication protocol is a heritage vehicle communication protocol including at least one of a protocol used by a CAN bus, a protocol used by a LIN bus, and a protocol used by a FlexRay bus, or combinations thereof, and wherein the second vehicle communication protocol is an newer vehicle communication protocol relative to the first vehicle communication protocol and includes at least one of a Data Distribution Services (DDS) protocol, an Ethernet protocol, and a Time Sensitive Network (TSN) protocol, or combinations thereof.

Clause 18: The method according to any of clauses 14-17, wherein the second vehicle communication protocol is configured for use with a vehicle configured for autonomous driving.

Clause 19: The method according to any of clauses 14-19, wherein the transport layer includes at least one transport interface configured for high-bandwidth data transport to each ECU of the plurality.

Clause 20: The method according to any of clauses 14-19, wherein at least one ECU of the plurality includes a sensor, and wherein the at least one transport interface is configured to transfer data generated by the sensor to an automotive computational and communications engine prior to transferring the data to other ECUs of the plurality.

All patents, patent applications, publications, or other disclosure material mentioned herein, are hereby incorporated by reference in their entirety as if each individual reference was expressly incorporated by reference respectively. All references, and any material, or portion thereof, that are said to be incorporated by reference herein are incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference, and the disclosure expressly set forth in the present application controls.

Various exemplary, and illustrative aspects have been described. The aspects described herein are understood as providing illustrative features of varying detail of various aspects of the present disclosure; and therefore, unless otherwise specified, it is to be understood that, to the extent possible, one or more features, elements, components, constituents, ingredients, structures, modules, and/or aspects of the disclosed aspects may be combined, separated, interchanged, and/or rearranged with or relative to one or more other features, elements, components, constituents, ingredients, structures, modules, and/or aspects of the disclosed aspects without departing from the scope of the present disclosure. Accordingly, it will be recognized by persons having ordinary skill in the art that various substitutions, modifications, or combinations of any of the exemplary aspects may be made without departing from the scope of the claimed subject matter. In addition, persons skilled in the art will recognize, or be able to ascertain using no more than routine experimentation, many equivalents to the various aspects of the present disclosure upon review of this specification. Thus, the present disclosure is not limited by the description of the various aspects, but rather by the claims.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one”, and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one”, and indefinite articles such as “a” or “an” (e.g., “a”, and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A. B, and C” would include but not be limited to systems that have A alone, B alone, C alone, A, and B together, A, and C together, B, and C together, and/or A. B. and C together, etc.). In those instances where a convention analogous to “at least one of A. B, or C, etc.” is used, in general such a construction is intended in the sense one having skill in the art would understand the convention (e.g., “a system having at least one of A. B, or C” would include but not be limited to systems that have A alone, B alone, C alone, A, and B together, A, and C together, B, and C together, and/or A. B, and C together, etc.). It will be further understood by those within the art that typically a disjunctive word, and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A, and B.”

With respect to the appended claims, those skilled in the art will appreciate that recited operations therein may generally be performed in any order. Also, although claim recitations are presented in a sequence(s), it should be understood that the various operations may be performed in other orders than those which are described, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,”, and the like means that a particular feature, structure, or characteristic described in connection with the aspect is included in at least one aspect. Thus, appearances of the phrases “in one aspect,” “in an aspect,” “in an exemplification,”, and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Directional phrases used herein, such as, for example, and without limitation, top, bottom, left, right, lower, upper, front, back, and variations thereof, shall relate to the orientation of the elements shown in the accompanying drawing, and are not limiting upon the claims unless otherwise expressly stated.

The terms “about” or “approximately” as used in the present disclosure, unless otherwise specified, means an acceptable error for a particular value as determined by one of ordinary skill in the art, which depends in part on how the value is measured or determined. In certain aspects, the term “about” or “approximately” means within 1, 2, 3, or 4 standard deviations. In certain aspects, the term “about” or “approximately” means within 50%, 200%, 105%, 100%, 9%, 8%, 7%, 6%, 5%, 4%, 3%, 2%, 1%, 0.5%, or 0.05% of a given value or range.

In this specification, unless otherwise indicated, all numerical parameters are to be understood as being prefaced, and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits, and by applying ordinary rounding techniques.

Any numerical range recited herein includes all sub-ranges subsumed within the recited range. For example, a range of “1 to 100” includes all sub-ranges between (and including) the recited minimum value of 1, and the recited maximum value of 100, that is, having a minimum value equal to or greater than 1, and a maximum value equal to or less than 100. Also, all ranges recited herein are inclusive of the end points of the recited ranges. For example, a range of “1 to 100” includes the end points 1, and 100. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

Any patent application, patent, non-patent publication, or other disclosure material referred to in this specification, and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material, and the existing disclosure material.

The terms “comprise” (and any form of comprise, such as “comprises”, and “comprising”), “have” (and any form of have, such as “has”, and “having”), “include” (and any form of include, such as “includes”, and “including”), and “contain” (and any form of contain, such as “contains”, and “containing”) are open-ended linking verbs. As a result, a system that “comprises,” “has,” “includes” or “contains” one or more elements possesses those one or more elements, but is not limited to possessing only those one or more elements. Likewise, an element of a system, device, or apparatus that “comprises,” “has,” “includes” or “contains” one or more features possesses those one or more features, but is not limited to possessing only those one or more features.

The foregoing detailed description has set forth various forms of the devices, and/or processes via the use of block diagrams, flowcharts, and/or examples. Insofar as such block diagrams, flowcharts, and/or examples contain one or more functions, and/or operations, it will be understood by those within the art that each function, and/or operation within such block diagrams, flowcharts, and/or examples can be implemented, individually, and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry, and/or writing the code for the software, and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

As used in any aspect herein, the term “control circuit” may refer to, for example, hardwired circuitry, programmable circuitry (e.g., a computer processor comprising one or more individual instruction processing cores, processing unit, processor, microcontroller, microcontroller unit, controller, digital signal processor (DSP), programmable logic device (PLD), programmable logic array (PLA), or field programmable gate array (FPGA)), state machine circuitry, firmware that stores instructions executed by programmable circuitry, and any combination thereof. The control circuit may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc. Accordingly, as used herein, “control circuit” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes, and/or devices described herein, or a microprocessor configured by a computer program which at least partially carries out processes, and/or devices described herein), electrical circuitry forming a memory device (e.g., forms of random access memory), and/or electrical circuitry forming a communications device (e.g., a modern, communications switch, or optical-electrical equipment). Those having skill in the art will recognize that the subject matter described herein may be implemented in an analog or digital fashion or some combination thereof.

As used in any aspect herein, the term “logic” may refer to an app, software, firmware, and/or circuitry configured to perform any of the aforementioned operations. Software may be embodied as a software package, code, instructions, instruction sets, and/or data recorded on non-transitory computer readable storage medium. Firmware may be embodied as code, instructions or instruction sets, and/or data that are hard-coded (e.g., nonvolatile) in memory devices.

As used in any aspect herein, the terms “component,” “system,” “module”, and the like can refer to a computer-related entity, either hardware, a combination of hardware, and software, software, or software in execution.

As used in any aspect herein, an “algorithm” refers to a self-consistent sequence of steps leading to a desired result, where a “step” refers to a manipulation of physical quantities, and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These, and similar terms may be associated with the appropriate physical quantities, and are merely convenient labels applied to these quantities, and/or states.

What is claimed is:

1. A method of programming a programmable unit of a vehicle, wherein the programmable unit interfaces with a plurality of electronic control units (“ECUs”) of the vehicle, the method comprising:
developing with a computer-based platform hosted on a server remote from the vehicle, software to be deployed on the programmable unit of the vehicle, wherein the computer-based platform comprises a hardware abstraction layer, a transport layer, and a service layer, wherein developing the software comprises:
interfacing, via the hardware abstraction layer, with the ECUs;
concealing, via the hardware abstraction layer, a vehicle-specific configuration of the ECUs;
eliminating, via the hardware abstraction layer, ECU-specific dependencies for the software;
integrating, via the transport layer, a first vehicle communication protocol associated with the software with a second vehicle communication protocol associated with the ECUs; and
developing, via the service layer, the software via a plurality of application programming interfaces (“APIs”); and
after developing the software, deploying the developed software to the vehicle for installation on the programmable unit.

2. The method of claim 1, wherein the server comprises a real-time response unit and an application unit configured to host the computer-based platform.

3. The method of claim 2, wherein the hardware abstraction layer comprises a plurality of vehicle-bus drivers, wherein the plurality of vehicle-bus drivers comprises a first subset of vehicle-bus drivers hosted on the real-time response unit and a second subset of vehicle-bus drivers hosted on the application unit.

4. The method of claim 3, wherein the vehicle-specific configuration of the ECUs is one of a plurality of ECU configurations the hardware abstraction layer is configured to interface with, and wherein developing the software further comprises:
detecting, via the plurality of vehicle-bus drivers, a similarity between the vehicle-specific configuration of the ECUs and other ECU configurations of the plurality, and
mapping, via the plurality of vehicle-bus drivers, the developed software to an ECU of the plurality based on the similarity.

5. The method of claim 4, wherein developing the software further comprises multiplexing, via the hardware abstraction layer, a plurality of messages simultaneously to the plurality of ECUs of the vehicle via a plurality of interfacing channels.

6. The method of claim 3, wherein the first subset of vehicle-bus drivers comprises at least one of a inter-processor communication (IPC) framework, a functional safety framework, an Ethernet driver, a control area network (CAN) driver, and a local interconnect network (LIN) driver, or combinations thereof.

7. The system of claim 6, wherein the second subset of vehicle-bus drivers comprises at least one of a second inter-processor communication (IPC) framework, a second functional safety framework, and a second Ethernet driver, or combinations thereof.

8. The method of claim 1, wherein the first vehicle communication protocol is a heritage vehicle communication protocol comprising at least one of a protocol used by a CAN bus, a protocol used by a LIN bus, and a protocol used by a FlexRay bus, or combinations thereof.

9. The method of claim 6, wherein the second vehicle communication protocol is a newer vehicle communication protocol relative to the first vehicle communication protocol and comprises at least one of a Data Distribution Services (DDS) protocol, an Ethernet protocol, and a Time Sensitive Network (TSN) protocol, or combinations thereof.

10. The method of claim 7, wherein the second vehicle communication protocol can be configured for use with a vehicle configured for autonomous driving.

11. The method of claim 1, wherein a first ECU of the plurality comprises a sensor and a second ECU of the plurality comprises an automotive computational and communications engine, and wherein the method further comprises transferring, via the developed software, data generated by the sensor to the automotive computational and communications engine prior to transferring the data to other ECUs of the plurality.

12. The system of claim 1, wherein the plurality of APIs comprises at least one of a data logging utility, a data analytics utility, a communication service utility, timing service utility, a security service utility, a cloud service utility, a diagnostic stack utility, a data distribution services utility, and an edge computing utility, or combinations thereof.

13. The system of claim 1, wherein the platform further comprises a message conversion software engine, and wherein developing the software further comprises:
receiving, via the message conversion software engine, files of varying formats from the plurality of ECUs; and
converting, via the message conversion software engine, the files into a universal format for development via the APIs of the service layer.

14. A system configured to develop architecture agnostic software for a vehicle comprising a plurality of electronic control units (“ECUs”), the system comprising:
a server configured to host a platform configured to interface with the plurality of ECUs, the platform comprising:
a hardware abstraction layer configured to interface with the plurality of ECUs wherein the hardware abstraction layer comprises a plurality of vehicle-bus drivers, and wherein the hardware abstraction layer is configured to conceal a specific hardware configuration of the the plurality of ECUs and eliminate hardware-specific dependencies for the plurality of ECUs;
a transport layer configured to integrate a first vehicle communication protocol, with a second vehicle communication protocol, wherein the first vehicle communication protocol and second vehicle communication protocol are configured to facilitate communications between the architecture agnostic software and the plurality of ECUs; and
a service layer, wherein comprising a plurality of application programming interfaces (“APIs”) standardized to provide a plurality of application services configured to enables the iteration of the architecture agnostic software.

15. The system of claim 14, wherein the platform is configured to be hosted on a real-time response unit and an application unit.

16. The system of claim 15, wherein the plurality of vehicle-bus drivers comprise a first subset of vehicle-bus drivers hosted on the real-time response unit and a second subset of vehicle-bus drivers hosted on the application unit, and wherein the first subset of vehicle-bus drivers comprises at least one of a functional safety framework, an Ethernet driver, a control area network (“CAN”) driver, and a local interconnect network (“LIN”) driver, or combinations thereof, and wherein the second subset of vehicle-bus drivers comprises at least one of a second inter-processor communication (“IPC”) framework, a second functional safety framework, and a second Ethernet driver, or combinations thereof.

17. The system of claim 1, wherein the first vehicle communication protocol is a heritage vehicle communication protocol comprising at least one of a protocol used by a CAN bus, a protocol used by a LIN bus, and a protocol used by a FlexRay bus, or combinations thereof, and wherein the second vehicle communication protocol is an newer vehicle communication protocol relative to the first vehicle communication protocol and comprises at least one of a Data Distribution Services (“DDS”) protocol, an Ethernet protocol, and a Time Sensitive Network (“TSN”) protocol, or combinations thereof.

18. The system of claim 17, wherein the second vehicle communication protocol can be configured for use with a vehicle configured for autonomous driving.

19. The system of claim 18, wherein the transport layer comprises at least one transport interface configured for high-bandwidth data transport to each ECU of the plurality.

20. The system of claim 9, wherein at least one ECU of the plurality comprises a sensor, and wherein the at least one transport interface is configured to transfer data generated by the sensor to an automotive computational and communications engine prior to transferring the data to other ECUs of the plurality.
